(19) United States
(12) Patent Application Publication
(10) Pub. No.: US 2017/0066679 A1
(43) Pub. Date: Mar. 9, 2017

(54) METHOD FOR CUTTING A LAMINATED ULTRA-THIN GLASS LAYER

(71) Applicant: SAINT-GOBAIN GLASS FRANCE, Courbevoie (FR)

(72) Inventor: Li-Ya YEH, Geilenkirchen (DE)

(73) Assignee: SAINT-GOBAIN GLASS FRANCE, Courbevoie (FR)

(21) Appl. No.: 15/122,898

(22) PCT Filed: Jan. 14, 2015
(86) PCT No.: PCT/EP2015/050540

§ 371 Date: Aug. 31, 2016

(30) Foreign Application Priority Data
Mar. 4, 2014 (EP) 14157625.6

(51) Int. Cl. C03B 33/09; C03B 33/07

(52) U.S. Cl. CPC C03B 33/093; C03B 33/078; B23K 2203/54

(57) ABSTRACT

A method and a device for cutting a laminate including at least one glass layer with a thickness less than or equal to 0.3 mm and including at least one polymeric layer are disclosed. The method includes generating a surface scratch on a first surface of the glass layer, wherein the scratch, starting from a lateral edge, extends along a cutting line. The method further includes moving a first laser beam, starting from the scratch, across the first surface along the cutting line. The method also includes cooling the glass layer along the cutting line, wherein the glass layer breaks along the cutting line The polymeric layer is severed by moving a second laser beam along the cutting line. The device includes means for cutting the laminate according to the disclosed method.

The invention relates to a method for cutting a laminated, ultrathin glass layer, a device suitable therefor, and the use of a glass layer cut using the method.

The term “ultrathin glass layers” typically means glass layers of a thickness up to roughly 0.3 mm. In addition to a low weight, they are distinguished in particular by their high, film-like flexibility. Ultrathin glass layers are, consequently, used in particular in flexible components, for example, in flexible thin-film solar cells, OLED elements or for film-like active glazing elements with electrically switchable properties. Ultrathin glass panes can be rolled up, as a result of which they are readily stored and transported. They also allow industrial processing in so-called “roll to roll” processes. In this regard, reference is made by way of example to EP 2 463 249 A1.

The cutting to size of ultrathin glass layers presents a challenge. Conventional mechanical glass cutting methods are unsuitable since they result in a rough cut edge with microcracks and other damage. Subsequent edge processing, as is customary with thicker glass panes, is impossible due to the low thickness. Laser cutting methods yield a better result and they have been applied to ultrathin glass layers, as, for example, in WO 2012/067042 A1 and WO 2013/050166 A1.

Laminated combinations of an ultrathin glass layer with a polymeric layer are also known, for example, from WO 2012/166343 A2. Such laminates are suitable as prefabricated starting products for industrial mass production in many fields of application. When the glass layer of such a laminate is cut using known laser methods, the parts of the glass layer are still held together by the polymeric layer. Another subsequent step for severing the polymeric layer is required, for example, by mechanical cutting.

The object of the present invention is to provide a method for cutting a laminated, ultrathin glass layer. The method should yield the smoothest possible cut edges, have a low risk of glass damage, and, in particular, provide the capability of cutting the laminate to size in one step.

The object of the present invention is accomplished according to the invention by a method for cutting a laminate composed of at least one glass layer and at least one polymeric layer in accordance with the independent claim 1. Preferred embodiments emerge from the subclaims.

The method according to the invention for cutting a laminate composed of at least one glass layer and at least one polymeric layer comprises at least the following process steps:

a) Generating a surface scratch on a first surface of the glass layer, wherein the scratch, starting from a lateral edge, extends along a cutting line,
b) Moving a first laser beam, starting from the scratch, across the first surface along the cutting line,
c) Cooling the glass layer along the cutting line, wherein the glass layer breaks along the cutting line.

By means of the process steps (a), (b), and (c), the glass layer is cut gently such that smooth cut edges are formed without disruptive damage. The polymeric layer is severed along the same cutting line by moving a second laser beam.

The severing of the polymeric layer can, in principle, be done before, simultaneously with, or after the cutting of the glass layer. In a preferred embodiment, the severing of the polymeric layer is done roughly simultaneously with the cutting of the glass layer, which enables faster cycling times for industrial production and is, consequently, advantageous. To this end, the movement of the second laser beam is preferably done at the same time (simultaneously) as the movement of the first laser beam or the movement of the means for cooling, if such a movement is provided.

The temporal order of the process steps (b) and (c) is not to be interpreted such that the laser radiation along the entire cutting line must be completed before the cooling begins. Instead, while the laser beam is still moving over the cutting line, it is possible to already begin the cooling of the regions of the cutting line already swept by the laser beam. Preferably, a means (device) for cooling is arranged behind the laser beam in the direction of movement, and the laser beam and means for cooling are moved along the cutting line at the same speed.

That surface of the glass layer that faces away from the polymeric layer is, in the context of the invention, referred to as the first surface. According to the invention, the first surface is provided with the scratch and the first surface is irradiated with the first laser beam and cooled. The irradiation with the laser beam is preferably done from the direction facing the first surface such that the laser beam does not have to penetrate the laminate before striking the first surface.

The glass layer of the laminate is, in particular, an ultrathin glass layer. In the context of the invention, the term “ultrathin glass layer” means a glass layer with a thickness less than or equal to 0.3 mm. The thickness of the glass layer is preferably from 0.03 mm to 0.3 mm, particularly preferably from 0.05 mm to 0.15 mm.

The method according to the invention is particularly readily usable on glass layers with these thicknesses and yields a cut glass with particularly smooth edges.

The surface scratch (or the surface notch) results in a concentration of stresses and defines the cutting line so to speak as a predetermined breaking line. The subsequent irradiation of the cutting line with a laser beam results in heating of the glass layer along the cutting line. As a result of the subsequent cooling, thermal stresses are produced, which automatically result in the breaking of the glass layer along the cutting line. An additional mechanical action (breaking by the application of pressure), as is necessary with thicker glass panes, is unnecessary with the cutting of the ultrathin glass according to the invention. The method is, consequently, very advantageous for industrial mass production. It has also been found that, with the method according to the invention, damage to the glass can be avoided and smooth cut edges are produced.

The scratch is generated according to the invention starting from a lateral edge of the glass layer and extends for a certain distance along the desired cutting line. The length of the scratch is preferably from 0.5 mm to 50 mm, particularly preferably from 1 mm to 20 mm, most particularly preferably from 2 mm to 10 mm. The depth of the surface scratch is preferably from 0.01 mm up to half the thickness of the glass, particularly preferably from 0.01 mm to 0.05 mm.

In an advantageous embodiment, the scratch is generated mechanically by means of a cutting tool, in particular with a diamond tool. The cutting tool is preferably connected to a controller, by means of which the movement of the tool and the pressure exerted by the tool can be controlled and regulated.

In an alternative advantageous embodiment, the surface scratch is generated by means of laser radiation. It has been found that a pulsed laser, in particular with pulses in the picosecond range, with a wavelength from 300 nm to 1200 nm is particularly suited to remove the surface glass layers without undesirable damage. Particularly suited is a doped YAG laser, particularly preferably an Nd:YAG laser, which has a wavelength of 1064 nm, but frequency doubled (532 nm) or frequency tripled (355 nm) operation is also possible. The pulse length is preferably from 1 ps to 20 ps; the pulse repetition frequency is preferably from 100 kHz to 800 kHz. it has been found that such a laser beam yields particularly good notches and the risk of undesirable glass damage is reduced. The speed of movement of the laser radiation over the glass surface is preferably from 1000 mm/s to 5000 mm/s. The laser radiation is preferably moved over the glass surface by means of a scanner and focused on the glass surface by means of an optical element, preferably with an f-theta lens.

It has been found that at excessively high laser powers, the risk of damage to the glass layer, which can later lead to breaking of the glass, increases. The power of the laser is preferably from 0.5 W to 3 W, particularly preferably from 0.5 W to 2 W, most particularly preferably from 0.8 W to 1.5 W. Powers in this range are adequate to generate the scratch but do not damage the glass surface.

After the surface scratch is generated, the surface is irradiated with a first laser beam along the desired cutting line. For this, the laser beam is moved, starting from the surface scratch, along the entire desired cutting line, i.e., usually all the way to the opposite side edge of the glass layer.

The glass layer is heated along the cutting line by the laser radiation. Consequently, laser radiation with a wavelength for which the glass layer has a high coefficient of absorption is particularly suitable. For this reason, laser radiation in the mid-infrared range is particularly suitable. The laser radiation preferably has a wavelength of 1 μm to 20 μm, particularly preferably from 5 μm to 15 μm. A CO₂ laser, typically with a wavelength of 9.4 μm or 10.6 μm, is particularly suitable.

The laser is preferably operated in continuous wave operation (CW). It has been found that good heating of the glass layer is thus obtained. In addition, continuous wave operation is technically simpler to accomplish than pulsed operation.

The laser radiation is preferably focused on the glass surface by means of an optical element or system, with, preferably, an elongated, roughly oval beam profile being generated, for example, by a cylindrical lens. The longer axis of the elongated beam profile is preferably aligned in the direction of the cutting line. The length of the beam profile on the glass surface is preferably from 10 mm to 50 mm; the width is preferably from 100 μm to 1 mm. Particularly good results are thus obtained, in particular with regard to a clean cut edge. The focal length of the optical element is, for example, from 100 mm to 200 mm. Good results are thus obtained.

The laser radiation is moved over the glass surface. This can be done, in principle, by moving the glass layer and/or by moving the laser radiation. In an advantageous embodiment, the laser radiation is moved over the (in particular stationary) glass layer. For this, laser scan devices known per se are suitable, in the simplest case, one or a plurality of tilting mirrors. The laser radiation can also be moved, for example, by movement of an optical waveguide, for example, a glass fiber, over the glass surface.

The laser radiation is preferably moved at a speed of 1 m/min to 30 m/min, particularly preferably from 5 m/min to 20 m/min, over the glass surface, most particularly preferably from 10 m/min to 15 m/min. Particularly good results are thus obtained.

The power of the laser radiation (output power) is preferably from 30 W to 1 kW, for example, from 50 W to 100 W. With such powers, adequate heating of the glass layer can be achieved. However, significantly higher powers can also be used.

After heating, the glass surface is cooled. The successive heating and cooling generate thermal stresses along the cutting line that automatically result in the desired breaking in the ultrathin glass layer. The cooling is preferably done by impingement of the glass surface with a gaseous and/or liquid coolant along the cutting line. The invention is not restricted to specific coolant. Preferred coolants are air and/or water, as such cooling is simple to realize and economical. An air/water mixture is particularly preferably used as coolant.

The coolant is preferably applied by means of a nozzle along the cutting line onto the glass surface. The nozzle is preferably moved over the glass surface behind the laser radiation at the same speed. The time difference between the heating of the glass layer by means of laser radiation and the cooling (“quenching”) of the glass layer is preferably from 10 ms to 500 ms, particularly preferably from 50 ms to 100 ms. Thus, particularly suitable thermal stresses, which result in an effective break with clean break edges, are generated.

The polymeric layer of the laminate according to the invention preferably includes a thermoplastic polymer, particularly preferably at least ethylene tetrafluoroethylene (ETFE), polyethylene terephthalate (PET), ethylene vinyl acetate (EVA), polyurethane (PU), and/or polyvinyl butyral (PVB). The polymeric layer can, however, also include, for example, polypropylene, polycarbonate, polymethyl methacrylate, polyacrylate, polyvinyl chloride, polyacetate resin, acrylates, fluorinated ethylene propylene and/or polyvinyl fluoride.

The polymeric layer preferably has a thickness in the range of the thickness of the glass layer. The thickness of the polymeric layer is preferably from 0.03 mm to 0.3 mm, particularly preferably von 0.05 mm to 0.15 mm. However, thicker polymeric layers can, in principle, also be processed.

In a particularly advantageous embodiment, the laminate comprises exactly one glass layer and at least one polymeric layer. If the laminate includes more than a single polymeric layer, all polymeric layers are preferably arranged as a layer stack on one side of the glass layer such that one surface of the glass layer (in the context of the invention, the first surface) is not bonded to a polymeric layer, but is, instead, exposed. The (first) surface of the glass layer facing away from the polymeric layer is provided with the surface scratch, heated with the first laser beam, and then cooled. The polymeric layer is irradiated with the second laser beam. The irradiation with the second laser beam for severing the polymeric layer can be done from the same direction as the irradiation with the first laser beam. In this case, the second laser beam must be transmitted through the glass layer, for which reason a wavelength that is absorbed as little as possible by the glass layer must be used for the second laser beam. Laser radiation in the visible spectral range is particularly suitable.

In a preferred embodiment, the polymeric layer is irradiated from the direction opposite the glass layer. In that case, the laser radiation need not penetrate the glass layer and the wavelength of the laser radiation need not be governed by the absorption behavior of the glass layer. A particular advantage here is that the same wavelength can be used for the first and the second laser beam. In a particularly preferred embodiment, the first laser beam used for cutting the glass layer and the second laser beam for severing the polymeric layer are generated by the same laser. The radiation of the laser is split by suitable optical elements into two subbeams that are guided such that they strike the laminate from opposite sides. The first laser beam and the second laser beam irradiate the laminate from opposite directions. The advantage resides in a simpler technical structure with only one laser source.

In a preferred embodiment, the first laser radiation and the second laser radiation are moved simultaneously.

In another particularly advantageous embodiment, the laminate includes two glass layers. The first glass layer is bonded to a second glass layer via the at least one polymeric layer. The glass cutting method with the generation of the surface scratch, the laser irradiation, and cooling is performed along a common cutting line on the outer (first) surfaces of the two glass layers facing away from the thermoplastic layer. The cutting of the first and second glass layer can be done successively in time, offset in time, or simultaneously, preferably simultaneously. The laser radiation necessary for this can be generated by the same laser.

The second glass layer preferably has a thickness in the range of the thickness of the first glass layer. The thickness of the second glass layer is preferably from 0.03 mm to 0.3 mm, particularly preferably from 0.05 mm to 0.15 mm.

In addition to the glass layers and the polymeric layer, the laminate can include other layers. For example, the laminate can be a thin-film solar cell or an active glazing element with switchable, in particular electrically switchable properties. Such glazings include active layers and electrode layers for electrical contacting. The laminate can, for example, be an electrochromic element, a PDLC element (polymer dispersed liquid crystal), an electroluminescent element, an organic light emitting diode (OLED), or an SPD element (suspended particle device). The functional principle of such glazing elements is well-known to the person skilled in the art, for example, from WO 2012007334 A1, US 20120026573 A1, WO 2010147494 A1, and EP 1862849 A1 (electrochromic), DE 102008026339 A1 (PDLC), US 2004227462 A1 and WO 2010112789 A2 (OLED), EP 0876608 B1 and WO 2011033313 A1 (SPD). As a result of the laminate according to the invention with the ultrathin glass layers, the glazing element has film-like flexibility and processability. With such glazing elements, conventional window glasses can, for example, be retrofitted in a simple manner with active, switchable functions.

The polymeric layer is irradiated by means of laser radiation through the first glass layer or the second glass layer. Thus, the thermoplastic layer is severed along the cutting line. Since the laser radiation must be transmitted through a glass layer, a wavelength that is absorbed as little as possible by the glass layer must be used for the laser radiation. In particular, laser radiation in the visible spectral range, near infrared range, or near UV range is suitable. The wavelength is preferably from 300 nm to 1200 nm. In a preferred embodiment, a doped YAG laser, particularly preferably an Nd:YAG laser, which has a wavelength of 1064 nm, but can be also operated frequency doubled (532 nm) or frequency tripled (355 nm), can be used. The severing of the thermoplastic layer is done, in a preferred embodiment, simultaneously with the cutting of the glass layers. However, a temporal succession of the various cutting steps is also possible.

The laser radiation for severing the polymeric layer is preferably pulsed, particularly preferably with pulses in the picosecond range. The pulse length is preferably from 1 ps to 10 ps; the pulse repetition frequency is preferably from 200 k Hz to 800 k Hz. The power is preferably from 5 W to 50 W. The laser radiation is preferably focused by means of a scanner and by means of an optical element on the thermoplastic layer, preferably with an f-theta lens.

An advantage of the method according to the invention for cutting ultrathin glass laminates is that it can easily be integrated into industrial mass production in which ultrathin glass layers are typically rolled up on a roll in the starting state. Consequently, in an advantageous embodiment, the glass laminate is unrolled from a roll immediately before cutting.

The glass layer or glass layers are not restricted to a specific type of glass. Instead, the method according to the invention is, in principle, applicable to ultrathin glass layers of any composition. The glass layer or glass layers include, for example, soda lime glass or borosilicate glass.

The invention further comprises a device for cutting a laminate composed of at least one glass layer and at least one polymeric layer, comprising at least:
a means for generating a surface scratch on a first surface of the glass layer, which is suitable to and provided to generate, starting from a lateral edge, the scratch along a cutting line,
a means for generating and moving a first laser beam, which is suitable to and provided to be moved, starting from the scratch, across the first surface along the cutting line,
a means for cooling the glass layer along the cutting line, and
a means for generating and moving a second laser beam, which is suitable to and provided to sever the polymeric layer along the cutting line.

The advantageous embodiments set forth above in conjunction with the method according to the invention apply similarly to the device.

The device further includes, in an advantageous embodiment, a roll holder, into which a roll provided with the ultrathin glass laminate can be inserted. The roll holder is arranged such that the glass laminate unrolled from the roll can be processed with the means for generating the scratch, the laser radiation, and the means for cooling.

The invention further includes the use of an ultrathin glass laminate cut according to the invention in a or as a thin-film solar cell or active glazing with switchable, in particular electrically switchable properties, preferably an electrochromic element, PDLC element (Polymer dispersed liquid crystal), electroluminescent element, an organic light emitting diode (OLED), or SPD element (suspended particle device).

The invention is explained in detail with reference to drawings and exemplary embodiments. The drawings are schematic representations and not to scale. The drawings in no way restrict the invention. They depict:

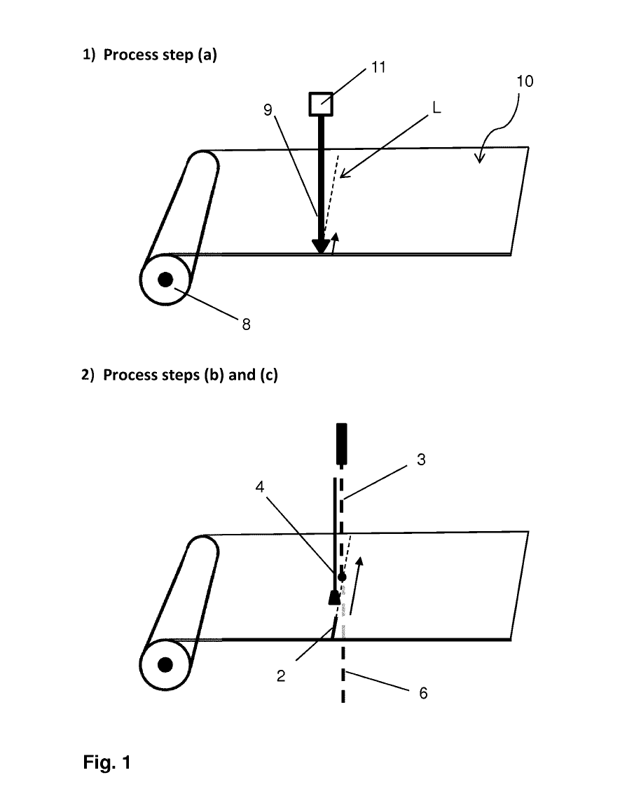

FIG. 1 a perspective view of an ultrathin glass laminate during the method according to the invention,

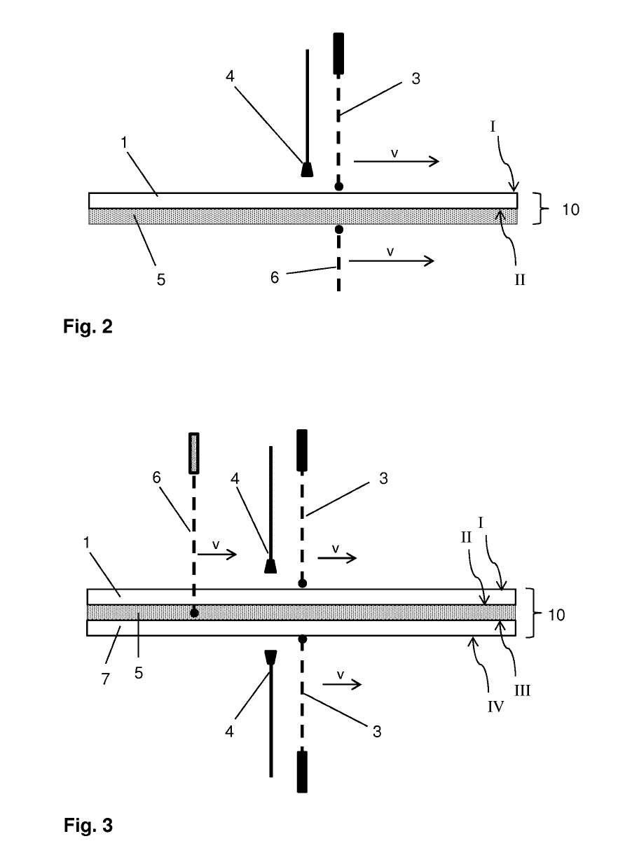

FIG. 2 a cross-section through the laminate along the cutting line L,

FIG. 3 a cross-section through another embodiment of the laminate, and

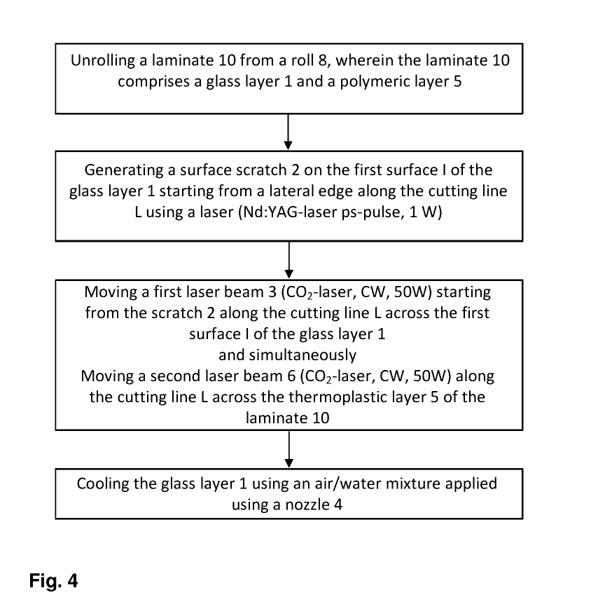

FIG. 4 an exemplary embodiment of the method according to the invention with reference to a flowchart.

FIG. 1 depicts a schematic representation of the method according to the invention. A laminate 10 with an ultrathin glass layer and a polymeric layer has been provided on a roll 8 and partially unrolled from the roll 8. The method according to the invention is applied to cut off a portion of the laminate 10 by means of a cut perpendicular to the unrolling direction.

In the first process step, a surface scratch 2 is introduced into the first surface of the glass layer facing away from the polymeric layer. The means 9 for introducing the scratch 2 is, for example, a diamond tool, whereby the movement and the pressure exerted can be regulated by a controller 11. Alternatively, the means 9 can also be, for example, an Nd:YAG laser with pulses in the picosecond range (for example, pulse length of 10 ps and pulse repetition frequency of 400 k Hz) and power of 1 W. The scratch 2 has, for example, a depth of 0.03 mm and a length of 5 mm and extends, starting from a lateral edge of the glass layer 1, along the desired cutting line L. The scratch 2 results in a concentration of stresses and defines the desired cutting line L, along which it extends over its length of 5 mm, as a predetermined breaking point.

Then, a first laser beam 3 is moved, starting from the scratch 2, along the cutting line L. The laser beam 3 is the beam of a CO₂ laser in continuous wave operation with a wavelength of 10.6 μm and power of 50 W. The laser beam 3 is focused with an elongated beam profile on the glass surface by means of a cylindrical lens (not shown). On the glass surface, the profile has, for example, a length of 30 mm and a width of 500 μm. The beam profile is aligned along the cutting line L; the long axis of the beam profile thus lies on the cutting line L. The laser beam 3 is effectively absorbed by the glass layer 1, by means of which the glass layer is heated along the cutting line L.

A nozzle 4 is moved behind the laser beam 3 along the cutting line L. The laser beam 3 and nozzle 4 move at the same speed. The glass layer is impinged on by means of the nozzle 4 with a coolant, for example, an air/water mixture. The rapid cooling of the heated glass layer results in thermal stresses, which result in the breaking of the glass layer 1 along the cutting line L.

The arrows depicted in the figure indicate the direction of movement.

A second laser beam 6 is focused on the thermoplastic layer 5 from the opposite direction. The second laser beam 6 is moved at the same speed v as the first laser beam 3 and the nozzle 4. The second and the first laser beam (3, 6) move, in particular, simultaneously such that the laser foci are situated in roughly the same position on the cutting line L. The laser beam 6 severs the thermoplastic layer 5. In a preferred embodiment, the laser beams 3 and 6 are generated by the same laser. However, it is also possible for the two beams 3, 6 to each be provided with its own laser.

As has been found, the breaking of the ultrathin glass takes place automatically due to the thermal stresses. Consequently, it is possible to dispense with active breaking through exertion of pressure. Therefore, the method according to the invention is suitable for industrial mass production where the glass layer is typically unrolled from a roll 8 and processed directly. Moreover, the process yields smooth cut edges without disruptive damage such as microcracks. The laminate 10 with the glass layer and the thermoplastic layer can be separated in one step by the method according to the invention, which is very advantageous from a production technology standpoint.

FIG. 2 depicts a cross-section through the laminate 10 during the method of FIG. 1. The laminate 10 comprises the glass layer 1, of which the second surface II is bonded to the polymeric, thermoplastic layer 5. The surface of the glass layer 1 facing away from the polymeric layer 5, on which surface the generation of the scratch, the irradiation with the first laser beam 3, and the impingement with the coolant take place, is referred to, in the context of the invention, as the first surface I. The glass layer 1 has a thickness of, for example, 100 μm. The thermoplastic layer 5 is made, for example, of a 100-μm-thick film made of ETFE.

The laser beam 3 and the nozzle 4 are successively moved at the speed v along the cutting line L. The second laser beam 6 is moved simultaneously at the same speed v.

FIG. 3 depicts a cross-section through another laminate. In this case, a first glass layer 1 is bonded to a second glass layer 7 via a polymeric layer 5. The surfaces II, III of the glass layers 1, 7 facing the polymeric layer 5 are, in the context of the invention, referred to as second surfaces. The surfaces I, IV facing away from the polymeric layer 5 are referred to as first surfaces. The polymeric layer 5 is again, for example, a thermoplastic film made of ETFE with a thickness of 100 μm.

The glass cutting method according to the invention with the surface scratch 2, the laser beam 3, and der nozzle 4 is executed simultaneously on the first surfaces I, IV of the glass layers 1, 7, by which means the glass layers are severed along a common cutting line L. A laser beam 6 is focused through the first glass layer 1 on the thermoplastic layer 5 and is moved at the same speed v as the other laser beams 3 and the nozzle 4 along the cutting line L. The laser beam 6 has, for example, a wavelength of 532 nm and is generated by a frequency doubled Nd:YAG laser. Light in the visible range, is not substantially absorbed by the glass layer 1 such that the laser beam 6 strikes the thermoplastic layer 5 largely unimpeded. The Nd:YAG laser is operated, for example, with pulses in the picosecond range (for example, pulse length of 10 ps and pulse repetition frequency of 400 k Hz) and has power of 1 W.

In the schematic representation, the second laser beam 6 is arranged behind the first two laser beams 3 and the nozzles 4 in the direction of movement. Thus, the cutting of the glass layers 1, 7 is done first, with the severing of the laminate temporally offset. The second laser beam 6 can, however, also be aimed at the position on the cutting line L on which the first laser beams 3, 6 are situated. Then, the cutting of the glass layers 1, 7 and the severing of the polymeric layer 5 are done simultaneously.

The laminate with the glass layers 1, 7 and the thermoplastic layer 5 can be separated in one step by the method according to the invention, which is very advantageous from a production technology standpoint.

FIG. 4 depicts an exemplary embodiment of the method according to the invention for cutting laminated, ultrathin glass layers.

### LIST OF REFERENCE CHARACTERS

(10) laminate
(1) (first) glass layer
(2) surface scratch
(3) laser radiation for cutting the glass layer 1
(4) nozzle for cooling the glass layer 1
(5) polymeric layer
(6) laser radiation for severing the polymeric layer 5
(7) second glass layer
(8) roll
(9) means for generating the surface scratch 2
(11) controller of the means 9
L cutting line
I first surface of the glass layer 1
II second surface of the glass layer 1
III first surface of the second glass layer 7
IV second surface of the second glass layer 7

1.-15. (canceled)

16. A method for cutting a laminate, comprising:
(a) providing a laminate including at least one glass layer with a thickness less than or equal to 0.3 mm, wherein the laminate further includes at least one polymeric layer;
(b) generating a surface scratch on a first surface of each of the at least one glass layer, wherein the scratch, starting from a lateral edge, extends along a cutting line;
(c) moving a first laser beam, starting from the scratch, across the first surface along the cutting line;
(d) cooling the at least one glass layer along the cutting line, wherein the at least one glass layer breaks along the cutting line; and
(e) severing the at least one polymeric layer by moving a second laser beam along the cutting line.

17. The method according to claim 16, wherein the first laser beam has a wavelength of 1 μm to 20 μm.

18. The method according to claim 16, wherein the first laser beam has a wavelength of 5 μm to 15 μm.

19. The method according to claim 16, wherein the first laser beam is generated by a CO₂ laser.

20. The method according to claim 19, wherein the first laser beam is generated in continuous wave operation.

21. The method according to claim 16, wherein the first laser beam and the second laser beam are generated by the same laser and irradiate the laminate from opposite directions.

22. The method according to claim 16,
wherein the at least one glass layer includes a first glass layer and a second glass layer,
wherein the first glass layer is bonded to the second glass layer via the at least one polymeric layer,
wherein the process steps (b), (c) and (d) are applied on a first surface of the first glass layer facing away from the at least one polymeric layer,
wherein the process steps (b), (c) and (d) are applied on a first surface of the second glass layer facing away from the at least one polymeric layer,
wherein the polymeric layer is irradiated with the second laser beam through the first glass layer or through the second glass layer, and
wherein the second laser beam has a wavelength of 300 nm to 1200 nm.

23. The method according to claim 22, wherein the second laser beam is generated by a doped YAG laser.

24. The method according to claim 23, wherein the doped YAG laser is an Nd:YAG laser.

25. The method according to claim 23, wherein the second laser beam is operated with pulses in the picosecond range.

26. The method according to claim 16, wherein the scratch has a length of 0.5 mm to 50 mm.

27. The method according to claim 16, wherein the scratch has a length of 1 mm to 20 mm.

28. The method according to claim 16, wherein the scratch has a length of 2 mm to 10 mm.

29. The method according to claim 16, wherein the scratch is mechanically generated.

30. The method according claim 16, wherein the scratch is generated by means of laser radiation.

31. The method according claim 30, wherein the laser radiation has a wavelength of 300 nm to 1200 nm and power of 0.5 W to 3 W.

32. The method according to claim 16, wherein the first laser beam is moved at a speed of 1 m/min to 30 m/min across the first surface.

33. The method according to claim 32, wherein the first laser beam and the second laser beam are moved at the same speed.

34. The method according to claim 16, wherein the first laser beam is moved at a speed of 5 m/min to 20 m/min across the first surface.

35. The method according to claim 16, wherein the cooling of the glass layer is done by impingement with a gaseous and/or liquid coolant along the cutting line.

36. The method according to claim 35, wherein the impingement with a gaseous and/or liquid coolant is by means of a nozzle.

37. The method according to claim 16, wherein the cooling of the glass layer is done by impingement with an air/water mixture.

38. The method according to claim 16, wherein the laminate is unrolled from a roll immediately before cutting.

39. A device for cutting a laminate including at least one glass layer and at least one polymeric layer, comprising:
means for generating a surface scratch on a first surface of the at least one glass layer of the laminate, wherein the at least one glass layer has a thickness less than or equal to 0.3 mm;
means for generating and moving a first laser beam, which is configured to be moved, starting from the scratch, along a cutting line across the first surface;
means for cooling the glass layer along the cutting line; and
means for generating and moving a second laser beam, which is configured to sever the polymeric layer of the laminate along the cutting line.

40. The device according to claim 39, further comprising a roll holder, into which a roll provided with the laminate can be inserted.

41. A method of using a laminate; comprising:
cutting a laminate with the method according to claim 16; and
installing the cut laminate in a thin-film solar cell or active glazing with switchable properties.

42. The method of using a laminate according to claim 41, wherein the switchable properties are electrically switchable.

43. The method of using a laminate according to claim 41, wherein installing the cut laminate includes providing an electrochromic element, an PDLC element (polymer dispersed liquid crystal), an electroluminescent element, an organic light emitting diode (OLED), or an SPD element (suspended particle device).
